(19) United States
(12) Patent Application Publication
(10) Pub. No.: US 2024/0395447 A1
(43) Pub. Date: Nov. 28, 2024

(54) ELECTROMAGNETIC ACTUATOR

(71) Applicant: Schaeffler Technologies AG & Co. KG, Herzogenaurach (DE)

(72) Inventors: Feixiang Zheng, Shanghai (CN); Zhiwei Li, Shanghai (CN); Yan Shi, Shanghai (CN)

(73) Assignee: Schaeffler Technologies AG & Co. KG, Herzogenaurach (DE)

(21) Appl. No.: 18/694,617

(22) PCT Filed: Sep. 23, 2021
(86) PCT No.: PCT/CN2021/119778

§ 371 Date: Mar. 22, 2024

(51) Int. Cl. H01F 7/16; H01F 7/121

(52) U.S. Cl. CPC H01F 7/1607; H01F 7/121

(57) ABSTRACT

An electromagnetic actuator comprises a housing, front and rear magnetic poles, and a guide sleeve. The front magnetic pole is fixed to the housing, the housing has a cavity, the cavity has a closed end and an open end, the open end is closed by the front magnetic pole, and the rear magnetic pole and the guide sleeve are mounted in the cavity; the guide sleeve has a first end facing the open end, a second end facing the closed end, an elastically deformable flange at the first end, and a radially stepped surface at an axially middle portion facing the closed end; the rear magnetic pole is axially abutted between the radially stepped surface and the closed end; and the flange is elastically abutted against the front magnetic pole, such that the guide sleeve and the rear magnetic pole are axially positioned with respect to the housing.

### CROSS-REFERENCE TO RELATED APPLICATIONS

This application is the U.S. National Phase of PCT Application No. PCT/CN2021/119778 filed on Sep. 23, 2021, the entire disclosure of which is incorporated by reference herein.

### TECHNICAL FIELD

The present disclosure relates to the technical field of electromagnetic actuators. Specifically, the present disclosure relates to an electromagnetic actuator having an improved mounting manner.

### BACKGROUND

In the modern industry, electromagnetic actuators are widely used. The electromagnetic actuators use magnetic forces, such as those generated by solenoids, to drive actuating mechanisms, thereby controlling the movement of mechanical components. For example, in an engine of a motor vehicle, an electromagnetic actuator may be used to control and adjust the valve lift of the engine.

FIG. 1 shows a design manner of an electromagnetic actuator in the prior art. This electromagnetic actuator comprises a housing 10, a front magnetic pole 20, a rear magnetic pole 30, a skeleton 40, a guide sleeve 50, an armature 60, and the like. The cavity enclosed by the housing 10 and the front magnetic pole 20 is used for mounting other components. The skeleton 40 for mounting a coil is made of plastic, such as PA66GF30, and other components are made of metal materials. During assembly, after the housing 10 and the front magnetic pole 20 are fixed together, the skeleton 40 is pressed between the housing 10 and the front magnetic pole 20 for being fixed with respect to the housing 10, and at the same time, the rear magnetic pole 30 is pressed between the housing 10 and a flange on the skeleton 40. After being pressed, a rib on the flange of the skeleton 40 will collapse and be deformed, thereby fixing the rear magnetic pole 30.

High temperatures are sometimes generated inside the electromagnetic actuator. At a high temperature, the material of the skeleton 40 will expand, causing the rib on the flange to be continuously compressed and deformed. However, when the temperature returns to normal, the deformed rib cannot return to an original state because the skeleton 40 is made of plastic. Therefore, the rear magnetic pole 30 can no longer be pressed in an axial direction by the housing 10 and the skeleton 40, so that the rear magnetic pole 30 cannot be maintained in contact with the housing 10. A spacing between the rear magnetic pole 30 and the housing 10 may cause an electromagnetic force loss. When the spacing between the rear magnetic pole 30 and the housing 10 is 0.1 mm, the electromagnetic force loss will exceed 10%. A larger spacing indicates a greater electromagnetic force loss. This significantly affects the actuation capability of the electromagnetic actuator.

### SUMMARY

Therefore, the technical problem to be solved by the present disclosure is to provide an improved electromagnetic actuator.

The above-mentioned technical problem is solved by the electromagnetic actuator according to the present disclosure. The electromagnetic actuator comprises a housing, a front magnetic pole, a rear magnetic pole, and a guide sleeve, wherein the front magnetic pole is fixed to the housing, the housing has a cavity, the cavity has a closed end and an open end axially opposite to each other, the open end is closed by the front magnetic pole, and the rear magnetic pole and the guide sleeve are mounted in the cavity; the guide sleeve has a first end facing the open end and a second end facing the closed end; the guide sleeve has an elastically deformable flange at the first end, and a radially stepped surface at an axially middle portion facing the closed end; the rear magnetic pole is axially abutted between the radially stepped surface and the closed end; and the flange is elastically abutted against the front magnetic pole, such that the guide sleeve and the rear magnetic pole are axially positioned with respect to the housing. Since the flange is elastically abutted against the front magnetic pole, when thermal expansion and contraction occur in the components in the electromagnetic actuator at different temperatures, the flange can compensate for the spacing formed between the guide sleeve and the front magnetic pole and between the rear magnetic pole and the housing through elastic deformation. Different from the fixation implemented by crushing plastic materials in the prior art, the deformation generated on the pressed flange when the spacing becomes smaller can return to an original shape when the spacing becomes larger again, thereby automatically adapting to the changes of the spacing. This ensures that the axial positioning of internal components remains stable during operation of the electromagnetic actuator. Usually, the guide sleeve is a thin-walled structure made of metal, so that the flange integrally formed on the guide sleeve has a good elastic deformation capability, which is sufficient to meet the above functional requirements.

According to an example embodiment of the present disclosure, the flange may extend obliquely toward the radially outer side with respect to the radial direction, so that the outer edge of the flange can be abutted against the front magnetic pole. Therefore, the flange has a structure similar to a diaphragm spring, which gives the flange the good elastic deformation capability.

According to an example embodiment of the present disclosure, the rear magnetic pole may have a third end facing the open end and a fourth end facing the closed end, the third end may be abutted against the radially stepped surface, and the fourth end may be abutted against the closed end. Therefore, the rear magnetic pole is axially integrally abutted between the radially stepped surface and the closed end.

According to an example embodiment of the present disclosure, the third end and/or the fourth end may have a flat end surface, thereby ensuring that the rear magnetic pole can be stably abutted against the radially stepped surface and/or the closed end.

According to an example embodiment of the present disclosure, the electromagnetic actuator may further comprise a skeleton for mounting a coil, and the skeleton may be fixed to the radially outer side of the rear magnetic pole. Therefore, the skeleton can be positioned in the cavity by means of the rear magnetic pole, eliminating the need for a direct fit relationship between the skeleton and the housing or the front magnetic pole.

According to an example embodiment of the present disclosure, the skeleton may be fixed to the radially outer side of the rear magnetic pole through overmolding. The skeleton may be made of plastic, and the rear magnetic pole may be made of metal, and the two can be conveniently fixed together through overmolding.

According to an example embodiment of the present disclosure, the skeleton may have a groove on an end surface facing the open end, and the flange may be accommodated in the groove. Preferably, the flange may be not in contact with the groove within a predetermined elastic deformation range of the flange. Especially, when the flange deflects toward the closed end under an axial pressure, the outer edge of the flange will be close to the side wall and the bottom wall of the groove, ensuring that the flange is not in contact with the side wall or the bottom wall of the groove within the predetermined elastic deformation range by design, thereby preventing interference in the elastic deformation of the flange.

### BRIEF DESCRIPTION OF THE DRAWINGS

The present disclosure will be further described below in conjunction with accompanying drawings. The same reference numerals in the drawings indicate elements with the same functions. In the drawings:

FIG. 1 shows a schematic diagram of an electromagnetic actuator according to the prior art; and

FIG. 2a, FIG. 2b, and FIG. 2c show schematic diagrams of an electromagnetic actuator according to an exemplary embodiment of the present disclosure.

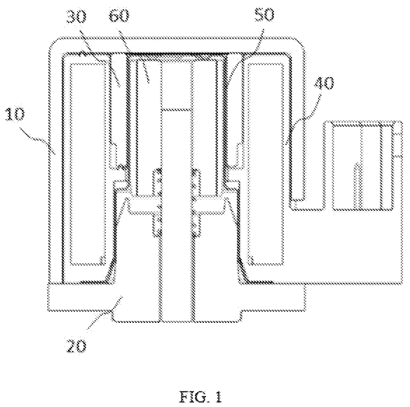

### DETAILED DESCRIPTION

Specific implementations of an electromagnetic actuator according to the present disclosure will be described below with reference to the accompanying drawings. The following detailed description and drawings are intended to exemplarily illustrate the principle of the present disclosure. The present disclosure is not limited to the described embodiments.

According to an example embodiment of the present disclosure, provided is an electromagnetic actuator capable of providing an actuation function through electromagnetic force. For example, this electromagnetic actuator may be used in a valve mechanism of an engine, to control on and off of the valve.

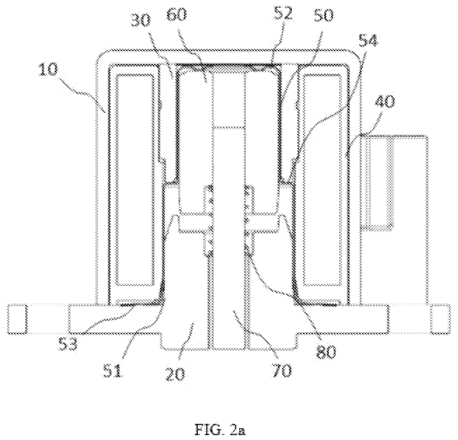

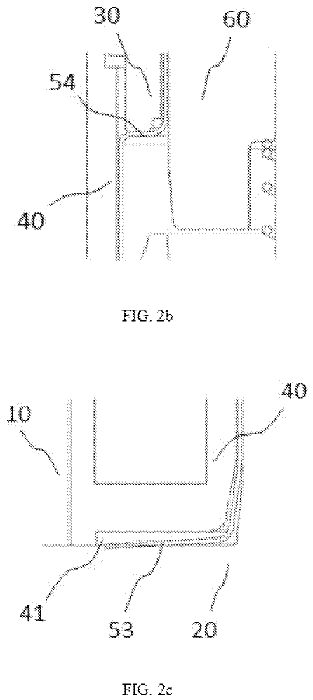

FIG. 2a, FIG. 2b, and FIG. 2c show schematic diagrams of an exemplary embodiment of an electromagnetic actuator according to the present disclosure. As shown in FIG. 2a, the electromagnetic actuator mainly comprises a housing 10, a front magnetic pole 20, a rear magnetic pole 30, a skeleton 40, a guide sleeve 50, an armature 60, and the like. The housing 10 is made of metal and has an axially extending cavity, wherein one end of the cavity is a closed end and the other end is an open end. The front magnetic pole 20 is fixed to the housing 10 and closes the cavity. Other components are encapsulated in the cavity by the housing 10 and the front magnetic pole 20.

The skeleton 40 is a cylindrical component made of plastic and other materials, whose axis is arranged along the axial direction of the cavity. A coil is mounted inside the skeleton, and the coil can generate an electromagnetic field when energized. The rear magnetic pole 30 is a cylindrical component made of metal materials, which is mounted substantially coaxially on the radially inner side of the skeleton 40.

The guide sleeve 50 is a cylindrical component made of metal, which has a thin-walled structure. The guide sleeve 50 is coaxially mounted on the radially inner side of the skeleton 40. The guide sleeve 50 has a first end 51 and a second end 52 axially opposite to each other. The first end 51 faces the open end of the cavity, and the second end 52 faces the closed end of the cavity.

The armature 60 is also a cylindrical component made of metal materials. The armature 60 is coaxially mounted on the radially inner side of the guide sleeve 50 and can axially move with the guidance of the inner wall of the guide sleeve 50. A columnar push rod 70 is fixedly mounted on the radially inner side of the armature 60, so as to axially move with the armature 60. One axial end of the push rod 70 penetrates through a through hole on the front magnetic pole 20 for extending out of the front magnetic pole 20 when moving, so as to push other components. A spring 80 is axially abutted between the front magnetic pole 20 and the armature 60. When the coil is powered off or the generated electromagnetic force is insufficient to overcome the elastic force of the spring 80, the spring 80 can push the armature 60 to move toward the second end 52 of the guide sleeve 50.

FIG. 2c shows an enlarged view of FIG. 2a at the first end 51 of the guide sleeve 50. As shown in FIG. 2c, the first end 51 of the guide sleeve 50 is an open end, and the guide sleeve 50 has a flange 53 extending out toward the radially outer side at the first end 51. The flange 53 may be an everted edge integrally formed with the guide sleeve 50. The flange 53 may have a circular contour. The flange 53 extends obliquely toward the radially outer side with respect to the radial direction, to form a funnel-shaped or trumpet-shaped structure. The oblique direction of the flange 53 causes the outer edge of the flange 53 to be further offset with respect to the inner edge in the direction toward the open end of the housing 10. Therefore, when the front magnetic pole 20 is fixed to the housing 10, the outer edge of the flange 53 will be abutted against the bottom surface of the front magnetic pole 20, while an area of the radially inner side of the flange 53 will not be in a direct contact with the front magnetic pole 20.

FIG. 2b shows an enlarged view of FIG. 2a at an axially middle portion of the guide sleeve 50. As shown in FIG. 2b, the guide sleeve 50 has a radially extending section at the axially middle portion, which axially divides the guide sleeve 50 into two parts with different radii. The radius of a first part close to the open end of the housing 10 is greater than that of a second part close to the closed end. A section extending radially between the two parts forms a transition stepped portion between the two parts, and the outer side surface of the transition stepped portion forms a radially stepped surface 54 facing the closed end of the housing 10.

The rear magnetic pole 30 surrounds the radially outer side of the second part of the guide sleeve 50 and is axially abutted between the radially stepped surface 54 and the closed end of the housing 10. The rear magnetic pole 30 has a third end and a fourth end axially opposite to each other, wherein the third end is axially abutted against the radially stepped surface 54, and the fourth end is axially abutted against the closed end of the housing 10. Both the third end and the fourth end may have a flat end surface for being stably abutted against the radially stepped surface 54 and the closed end of the housing 10.

When the rear magnetic pole 30 and the guide sleeve 50 are mounted inside the housing 10 via the front magnetic pole 20, the guide sleeve 50 is always in a state of being oppositely squeezed by the front magnetic pole 20 and the rear magnetic pole 30, so that the flange 53 maintains elastic deformation. The elastic force generated by the elastically deformed flange 53 acts on the front magnetic pole 20 on the one hand, and acts on the rear magnetic pole 30 via the radially stepped surface 54 on the other hand, so that the guide sleeve 50 and the rear magnetic pole 30 are axially pressed together between the front magnetic pole 20 and the closed end of the housing 10, thereby achieving axial positioning of the two in the cavity. When dimensional changes occur in the components of the electromagnetic actuator due to, for example, temperature changes, the flange 53 can adapt to such dimensional changes through elastic deformation, so that the guide sleeve 50 and the rear magnetic pole 30 can always be stably pressed between the front magnetic pole 20 and the closed end of the housing 10 without causing an axial spacing.

The rear magnetic pole 30 may be further used to position the skeleton 40. Specifically, the rear magnetic pole 30 and the skeleton 40 may be fixed together. For example, the rear magnetic pole 30 is made of metal, and the skeleton 40 is made of plastic, so the skeleton 40 may be fixed to the radially outer side of the rear magnetic pole 30 through overmolding. In this case, since an axial location of the rear magnetic pole 30 is limited, an axial location of the skeleton 40 is also limited. At this time, there may be an axial spacing between at least one end of the skeleton 40 (especially the end facing the closed end) and the closed end or the front magnetic pole 20, so as to allow the skeleton 40 to move slightly with respect to the housing 10 when elastic deformation occurs on the flange 53. Compared with the prior art, since the skeleton 40 does not need to form a flange and a rib any longer, the structure is significantly simplified, which helps to reduce the production cost of the electromagnetic actuator.

As shown in FIG. 2b, a groove 41 may be further formed on an end surface of the skeleton 40 facing the open end. The groove 41 is axially recessed from the end surface of the skeleton 40 and may have, for example, a circular outer contour corresponding to that of the flange 53. The flange 53 is accommodated in the groove 41. The dimension of the groove 41 allows the elastic deformation of the flange 53 inside the groove without hindrance. Specifically, the flange 53 is never in contact with the inner wall of the groove 41 within a predetermined elastic deformation range of the flange 53. Particularly, the outer edge of the flange 53 is not in contact with the side wall and the bottom wall of the groove 53. This means that the radial dimension of the groove 41 should be slightly greater than the maximum radial dimension of the flange 53. The predetermined elastic deformation range of the flange 53 refers to all possible elastic deformation ranges of the flange 53 under all operation conditions allowed by design.

The embodiment of the present disclosure aims to achieve stable mounting of the guide sleeve 50 and the rear magnetic pole 30 through the elastic flange 53 of the guide sleeve 50. On this basis, various changes can be made to other structural components of the electromagnetic actuator and are not limited to the specific structure shown in the figures.

Although possible embodiments have been described illustratively in the above description, it should be understood that there are still a large number of embodiment variations through combinations of all known technical features and implementations as well as those are readily apparent to those skilled in the art. In addition, it should be further understood that the exemplary implementations are just examples and shall not in any way limit the scope of protection, application and construction of the present disclosure. The foregoing description is more intended to provide those skilled in the art with a technical guide for converting at least one exemplary implementation, in which various changes, especially changes in the functions and structures of the components, can be made as long as they do not depart from the scope of protection of the claims.

### LIST OF REFERENCE NUMERALS

10 Housing
20 Front magnetic pole
30 Rear magnetic pole
40 Skeleton
41 Groove
50 Guide sleeve
51 First end
52 Second end
53 Flange
54 Radially stepped surface
60 Armature
70 Push rod
80 Spring

1. An electromagnetic actuator, comprising:
a housing defining a cavity, the cavity having a closed end and an open end axially opposite to each other,
a front magnetic pole fixed to the housing, the front magnetic pole configured to close the open end of the cavity,
a rear magnetic pole mounted in the cavity, and
a guide sleeve mounted in the cavity, the guide sleeve having:
a first end facing the open end,
a second end facing the closed end,
an elastically deformable flange at the first end, and
a radially stepped surface, at an axially middle portion facing the closed end, and
the rear magnetic pole is axially abutted between the radially stepped surface and the closed end, and
the elastically deformable flange is elastically abutted against the front magnetic pole, such that the guide sleeve and the rear magnetic pole are axially positioned with respect to the housing via the elastically deformable flange.

2. The electromagnetic actuator according to claim 1, wherein the elastically deformable flange extends obliquely in a radial outward direction, such that a radial outer edge of the elastically deformable flange is abutted against the front magnetic pole.

3. The electromagnetic actuator according to claim 1, wherein the rear magnetic pole has comprises:
a third end facing the open end, the third end abutted against the radially stepped surface, and
a fourth end facing the closed end, the fourth end abutted against the closed end.

4. The electromagnetic actuator according to claim 3, wherein at least one of the third end or the fourth end has a flat end surface.

5. The electromagnetic actuator according to claim 1, further comprising a skeleton configured for mounting a coil, and the skeleton is fixed to a radially outer side of the rear magnetic pole.

6. The electromagnetic actuator according to claim 5, wherein the skeleton is fixed to the radially outer side of the rear magnetic pole via overmolding.

7. The electromagnetic actuator according to claim 5, wherein the skeleton has a groove arranged on an end surface facing the open end, and the groove is configured to receive the elastically deformable flange.

8. The electromagnetic actuator according to claim 7, wherein the elastically deformable flange is not in contact with the groove within a predetermined elastic deformation range of the elastically deformable flange.

9. The electromagnetic actuator according to claim 8, wherein the guide sleeve is a thin-walled structure constructed of metal.

10. The electromagnetic actuator according to claim 5, further comprising:
an armature coaxially mounted on a radially inner side of the guide sleeve,
a push rod fixedly mounted on a radially inner side of the armature so as to axially move with the armature, and one axial end of the push rod penetrates through a through hole of the front magnetic pole.

11. The electromagnetic actuator according to claim 10, wherein the armature is disposed within the guide sleeve.

12. The electromagnetic actuator according to claim 10, further comprising a skeleton configured to mount a coil within the housing, and the guide sleeve extends in an axial direction between the skeleton and the front magnetic pole.

13. An electromagnetic actuator, comprising:
a housing,
a front magnetic pole fixed to an open end of the housing,
a rear magnetic pole mounted in the housing, and
a thin-walled guide sleeve disposed in the housing, the thin-walled guide sleeve having:
a radially stepped surface configured to axially abut with the rear magnetic pole within the housing,
an elastically deformable flange configured to springably engage the front magnetic pole so as to springably mount the rear magnetic pole within the housing.

14. The electromagnetic actuator according to claim 13, wherein the rear magnetic pole has a first end configured to abut with a closed end of the housing and a second end configured to axially abut with the radially stepped surface.

15. The electromagnetic actuator according to claim 13, further comprising a skeleton configured to mount a coil within the housing, and the thin-walled guide sleeve extends in an axial direction between the skeleton and the front magnetic pole.

16. The electromagnetic actuator according to claim 13, wherein the elastically deformable flange extends obliquely in a radial outward direction such that a radial outer edge of the elastically deformable flange is abutted against the front magnetic pole.

17. The electromagnetic actuator according to claim 16, further comprising a skeleton configured to mount a coil within the housing, and a groove arranged on an end surface of the skeleton is configured to receive the elastically deformable flange.

18. An electromagnetic actuator, comprising:
a housing,
a skeleton configured for mounting a coil within the housing,
a cylindrical rear magnetic pole disposed within the skeleton,
a cylindrical guide sleeve disposed in the housing, the cylindrical guide sleeve extending from an end of the skeleton to a closed end of the housing,
an armature disposed within the cylindrical guide sleeve and configured to move axially via an electromagnetic force generated by the coil, and
a front magnetic pole fixed to an open end of the housing, the front magnetic pole configured to deflect an elastically deformable flange formed on a first end of the cylindrical guide sleeve so as to generate an elastic force configured to axially press the cylindrical guide sleeve and the cylindrical rear magnetic pole against the housing.

19. The electromagnetic actuator of claim 18, wherein the armature is configured to move axially via guidance of an inner wall of the cylindrical guide sleeve.

20. The electromagnetic actuator of claim 19, wherein the armature comprises a radially stepped surface configured to abut with an end of the cylindrical rear magnetic pole.
